(19) United States
(12) Patent Application Publication
(10) Pub. No.: US 2015/0046854 A1
(43) Pub. Date: Feb. 12, 2015

(54) METHODS, COMPUTER-READABLE MEDIA, AND SYSTEMS FOR ASSOCIATING AN EVENT WITH ONE OF A PLURALITY OF TILES

(71) Applicant: E2E Ventures Ltd., Road Town (VG)

(72) Inventor: Aaron Fleming, Barcelona (ES)

(21) Appl. No.: 13/963,542

(22) Filed: Aug. 9, 2013

(51) Int. Cl. G06F 3/0484

(52) U.S. Cl. CPC G06F 3/0484
USPC 715/763

(57) ABSTRACT

One aspect of the invention provides a method of associating an event with one of a plurality of tiles. The method includes: receiving an event specifying at least an x coordinate and a y coordinate of a user interface; identifying a subset of candidate tiles by identifying a plurality tiles in which the x coordinate is between a minimum x coordinate and a maximum x coordinate of the tile and the y coordinate is between a minimum y coordinate and a maximum y coordinate of the tile; determining whether the event lies within each of the candidate tiles until a relevant tile is identified; and returning information regarding the relevant tile.

### BACKGROUND User interfaces must be designed to be simple yet robust. A user interface that is complicated or unreliable can result in a poor user experience. Improved user interfaces are needed.

### SUMMARY OF THE INVENTION

One aspect of the invention provides a method of associating an event with one of a plurality of tiles. The method includes: receiving an event specifying at least an x coordinate and a y coordinate of a user interface; identifying a subset of candidate tiles by identifying a plurality tiles in which the x coordinate is between a minimum x coordinate and a maximum x coordinate of the tile and the y coordinate is between a minimum y coordinate and a maximum y coordinate of the tile; determining whether the event lies within each of the candidate tiles until a relevant tile is identified; and returning information regarding the relevant tile.

This aspect of the invention can have a variety of embodiments. The plurality of tiles can be rhombuses. The rhombuses can be squares. A first pair of opposite vertices of each of the squares can lie parallel to an x axis of the user interface and a second pair of opposite vertices of each of the squares can lie parallel to a y axis of the user interface. The step of determining whether the event lies within each of the candidate tiles can include: determining whether the event lies within a triangle corresponding to an upper half of the rhombus and determining whether the event lies within a triangle corresponding to a lower half of the rhombus. The plurality of tiles can be selected from the group consisting of: circles, ovals, and n-gons.

Another aspect of the invention provides a computer-readable medium storing instructions for implementing a method of associating an event with one of a plurality of tiles. The implemented method includes: receiving an event specifying at least an x coordinate and a y coordinate of a user interface; identifying a subset of candidate tiles by identifying a plurality tiles in which the x coordinate is between a minimum x coordinate and a maximum x coordinate of the tile and the y coordinate is between a minimum y coordinate and a maximum y coordinate of the tile; determining whether the event lies within each of the candidate tiles until a relevant tile is identified; and returning information regarding the relevant tile.

This aspect of the invention can have a variety of embodiments. The plurality of tiles can be rhombuses. The rhombuses can be squares. A first pair of opposite vertices of each of the squares can lie parallel to an x axis of the user interface and a second pair of opposite vertices of each of the squares can lie parallel to a y axis of the user interface. The step of determining whether the event lies within each of the candidate tiles can include: determining whether the event lies within a triangle corresponding to an upper half of the rhombus and determining whether the event lies within a triangle corresponding to a lower half of the rhombus. The plurality of tiles can be selected from the group consisting of: circles, ovals, and n-gons.

Another aspect of the invention provides a system comprising a processor and memory, the memory storing instructions for implementing a method of associating an event with one of a plurality of tiles. The method includes: receiving an event specifying at least an x coordinate and a y coordinate of a user interface; identifying a subset of candidate tiles by identifying a plurality tiles in which the x coordinate is between a minimum x coordinate and a maximum x coordinate of the tile and the y coordinate is between a minimum y coordinate and a maximum y coordinate of the tile; determining whether the event lies within each of the candidate tiles until a relevant tile is identified; and returning information regarding the relevant tile.

This aspect of the invention can have a variety of embodiments. The plurality of tiles can be rhombuses. The rhombuses can be squares. A first pair of opposite vertices of each of the squares can lie parallel to an x axis of the user interface and a second pair of opposite vertices of each of the squares can lie parallel to a y axis of the user interface. The step of determining whether the event lies within each of the candidate tiles can include: determining whether the event lies within a triangle corresponding to an upper half of the rhombus and determining whether the event lies within a triangle corresponding to a lower half of the rhombus. The plurality of tiles can be selected from the group consisting of: circles, ovals, and n-gons.

### FIGURES

For a fuller understanding of the nature and desired objects of the present invention, reference is made to the following detailed description taken in conjunction with the accompanying drawing figures wherein:

FIG. 1A depicts a user interface for a software tool according to an embodiment of the invention;

FIG. 1B depicts a schematic of a plurality of square-shaped facets according to an embodiment of the invention;

FIG. 2 depicts a map interface according to an embodiment of the invention; and

FIG. 3 depicts a method of associating an event with one of a plurality of tiles according to an embodiment of the invention.

### DESCRIPTION OF THE INVENTION

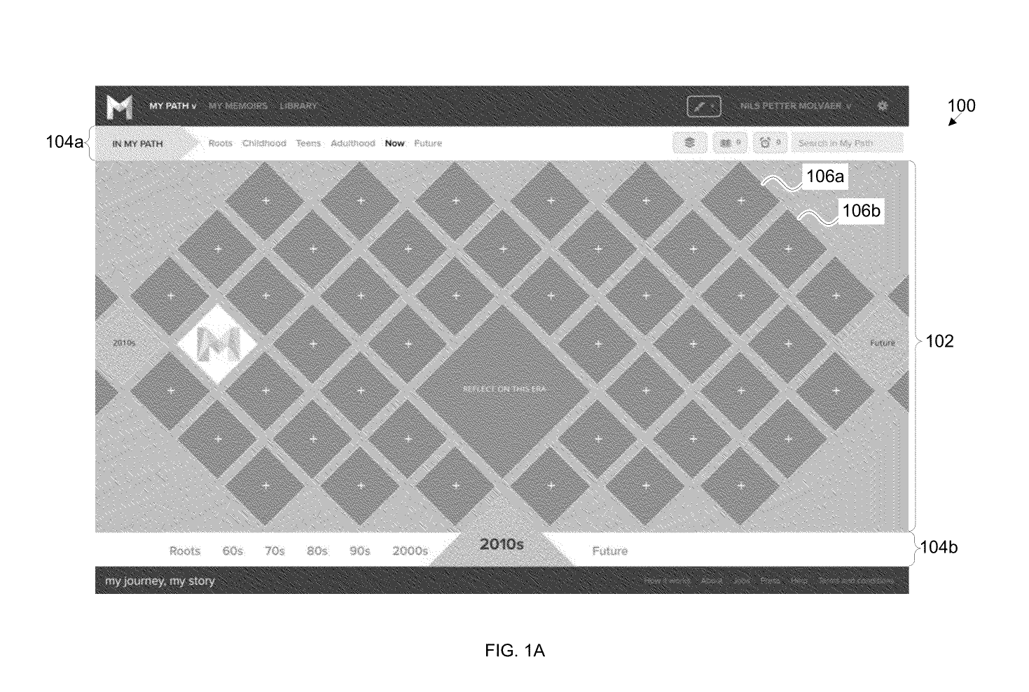

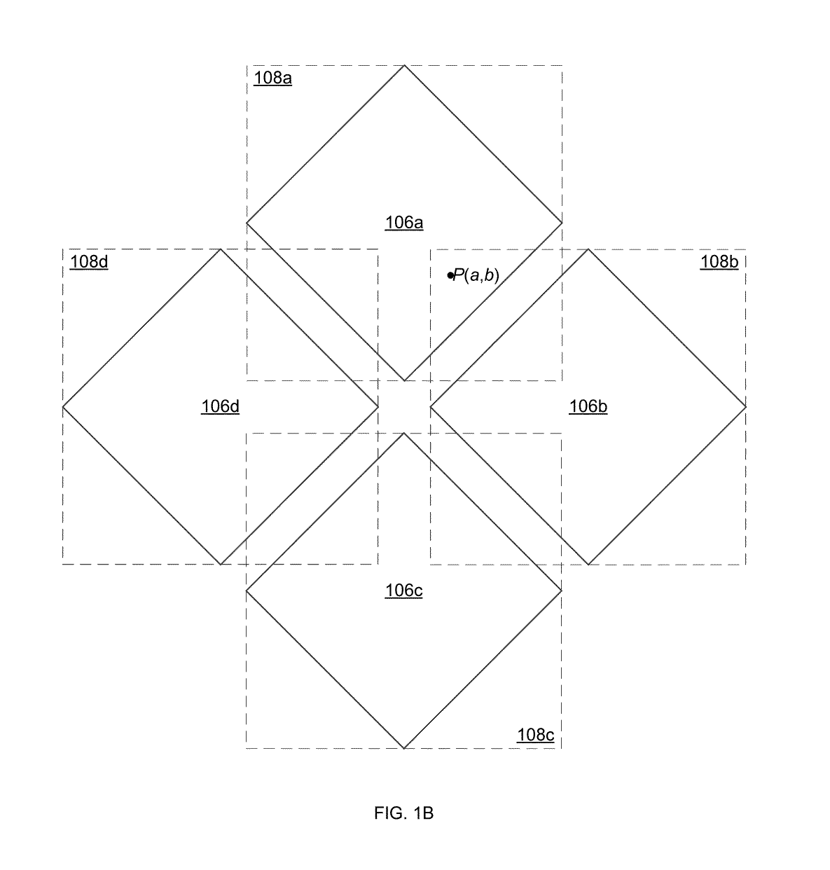

Referring now to FIG. 1A, one embodiment of the invention provides a user interface 100 for a software tool that enables users to capture, log, and reflect on moments in their lives, as one would do if they wished to create a “collection of memoirs.” The software tool also enables the user to create future goals and celebrate the success of life's achievements.

The software tool empowers the individual to be self-aware and to rediscover themselves through examination of moments in their life that have contributed to their personal journey and thus have more conscious control of future actions and decisions they take and thereby the legacy they will leave behind.

The software tool includes a platform to log and contextualize a user's moments within a facet board 102, as well as the means with which to analyze and learn each moment they record. The user can document a collection of moments that would contribute to creating an autobiography of their life. There will be various outputs of the autobiography that form potential revenue streams.

The software tool enables the user to reconnect to their lives and document their past, present, and future experiences within an engaging and creative way. These events are collected to build a collection of memoirs associated to their life's experiences.

The software tool allows users to identify “who they are” by embarking on a voyage of self-discovery. Through gentle guidance from the software tool, the user can recognize the impacts and influences within their lives that have contributed to the person they have become. The “Roots” area of the user interface encourages the user to think back to the past, not only to events and memories that were significant not only in their lives, but the lives of their ancestors. In this area, the user is asked to record these moments by adding detail, photos, links (e.g., what was/is happening in the world at that time) and other users who are connected to this event. The tool will incorporate a Reflection section within each era that encourages the user to recognize and reminisce about the feelings and emotions around that event (e.g., “how did it make the user feel?”). By recognizing the emotion associated to the event, the user is able create and have a snapshot of their lives in emotions.

The software tool excites the user and instigates a mind journey by connecting to the eras identified on the one or more navigation bars 104a, 104b. The software tool can present eras such as Roots, Childhood, Teens, Adolescence, Adulthood, Now, and Future (seen in navigation bar 104a). Within each era, the user can be presented with an facet board interface 102 that is made up of facets 106 as seen for the 2010s era in FIG. 1A. These facets 106 represent moments the user collects to capture memories and/or events and start to build their life path.

Navigation bar 104b can allow the user to display a facet board for a particular decade dependent on the user's birthdate. This design has been specifically created to reduce any alienation that could be created through age.

The software tool is designed in a user-friendly format, directing the user to collect the types of information required within our memory banks. This feature includes collecting photos, videos, web reference links, diary extracts, and newspaper cuttings, linking associated people, and recording where the event occurred.

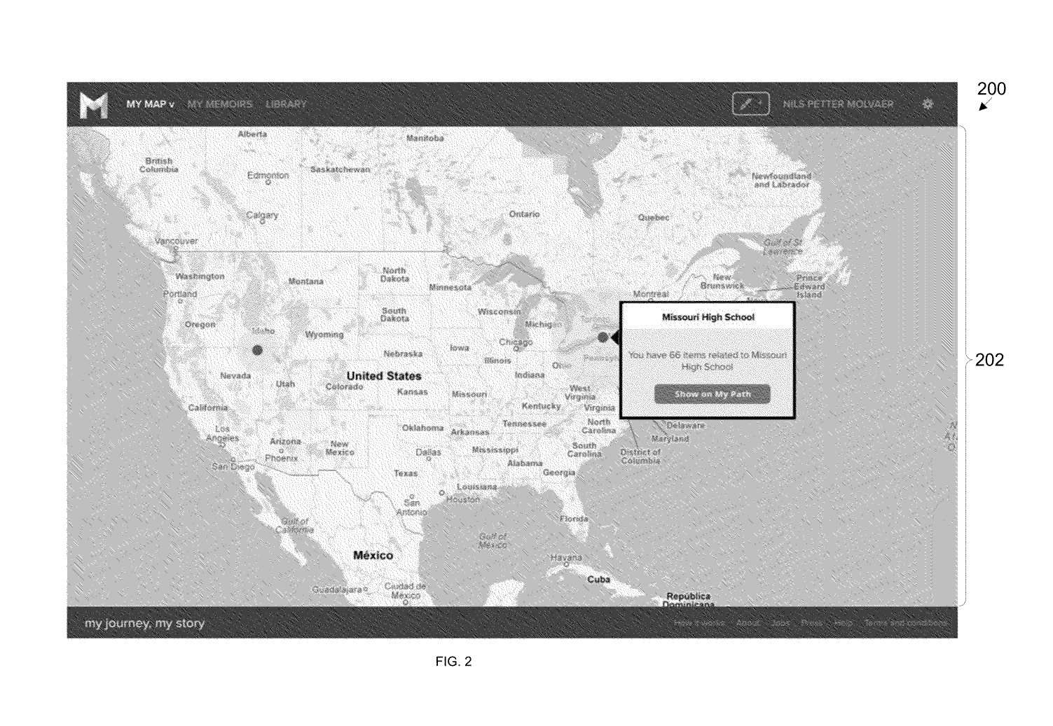

By storing an event's location, the user automatically creates a “My Map” interface 200 including a map 202 as depicted in FIG. 2. This alternative view of the user's life illustrates the places the user has been, locally or globally. The map 202 will zoom into the key geographic location of the user's life in order to not alienate less-traveled users. Events can be color-coded to illustrate the amount of events that occurred in this location. The map 202 can be an alternative view.

The software tool also enables users to “interpret” these moments by writing the content of the moment. For example, were particular events coincidences, blessings, influences beyond the user's control, etc.? This process is significant because it encourages the user to really understand how they felt, how they have been living life, and what impressions these memories have made within them. People often don't look back at events in their lives to see how they impacted the. A key advantage of the software tool is to encourage this reflection to evoke change and self-development through self-realization.

Recording emotions through the software tool creates data that can be analyzed to provide a deeper awareness of when the user was in alignment with their true self. For example, through identifying periods in their life when they were happy, users can recall that moment and deepen that experience within their mind, body, and soul. The user can recognize driving factors that contributed to this moment and utilize those factors when creating their future aspirations.

Referring again to FIG. 1A, the facet board interface 102 includes a plurality of facets 106. Although facets 106 are depicted in FIG. 1A as squares, facets 106 can have other shapes such as quadrilaterals, rectangles, parallelograms, rhombuses, triangles, n-gons, circles, ovals, irregular shapes, freeform shapes, and the like.

In the embodiment depicted in FIG. 1A, facets 106 are squares positioned such that a first pair of opposite vertices of each of the squares lies parallel to an x axis of user interface 100 and a second pair of opposite vertices of each of the squares lies parallel to a y axis of user interface 100.

Referring now to FIG. 1B, a plurality of square-shaped facets 106a-d are depicted. Although the square-shaped facets 106a-d are depicted as discrete, non-overlapping shapes, each facet 106 is conceptually viewed for purposes of identifying a click as a rectangle 108 having sides parallel to x and y axes of the user interface 100. Thus, it is possible that when a user clicks on a point P having coordinates (a, b), point P lies within the x and y boundaries of two adjacent squares 106a, 106b as reflected by rectangles 108a, 108b.

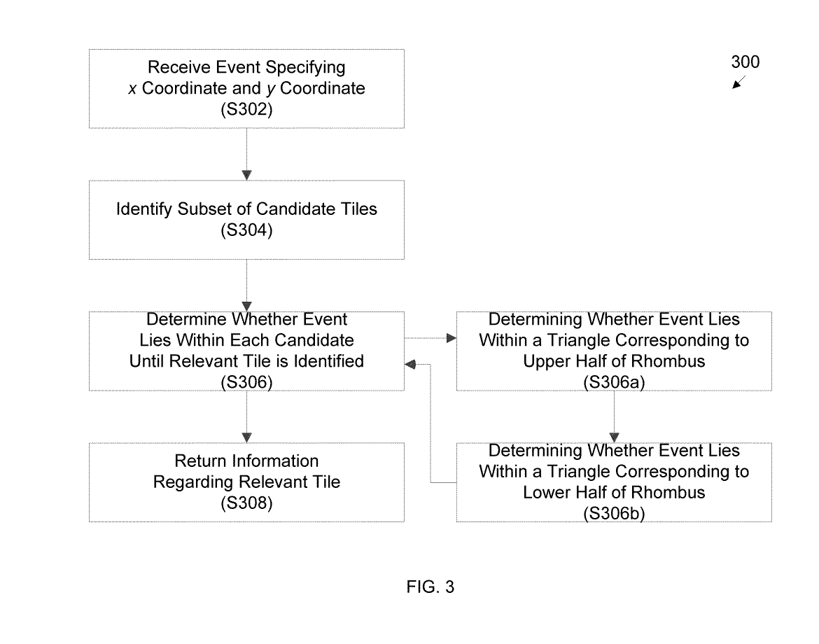

In order to determine which tile an event is associated with, an embodiment of the invention provides a method 300 depicted in FIG. 3.

In step S302, an event specifying at least an x coordinate and a y coordinate of a user interface is received. The event can be a mouse click as discussed above, or can be any other event (e.g., generated by an input device) such as a finger touch, a stylus touch, and the like.

In step S304, a subset of candidate tiles are identified. The candidate tiles are all times in which the x coordinate is between a minimum x coordinate and a maximum x coordinate of the tile and the y coordinate is between a minimum y coordinate and a maximum y coordinate of the tile. As can be clearly seen in FIG. 1B, the subset of candidate tiles will be 106a and 106b.

In step S306, a determination is made whether each of the candidate tiles until a relevant tile is identified. In one embodiment, this determination is made by determining whether the event lies within one or more sub-regions of the tile. For example, if the tile is a square as depicted in FIG. 1B, it can be determined whether the event lies within a triangle corresponding to an upper half of the rhombus (step S306a) and then determined whether the event lies within a triangle corresponding to a lower half of the rhombus (step S306b).

Exemplary JAVASCRIPT™ source code for determining whether an event (x, y) lies within a triangle defined by three points, p1, p2, and p3, is provided below:

```
function inTriangle(x,y,p1x,p1y,p2x,p2y,p3x,p3y) {
  var asx = x − p1x;
  var asy = y − p1y;
  isAB = ( p2x − p1x ) * asy − ( p2y − p1y ) * asx
> 0;
  if ( ( p3x − p1x ) * asy − ( p3y − p1y ) * asx >
0 == isAB ) {return false;}
  if ( ( p3x − p2x ) * ( y − p2y ) − ( p3y − p2y )
* ( x − p2x ) > 0 != isAB ) {return false;}
  return true;
}
```

In step S308, information regarding the relevant tile is returned. This information can include, for example, an identifier associated with the relevant tile.

### INCORPORATION BY REFERENCE

All patents, published patent applications, and other references disclosed herein are hereby expressly incorporated by reference in their entireties by reference.

### EQUIVALENTS

The functions of several elements may, in alternative embodiments, be carried out by fewer elements, or a single element. Similarly, in some embodiments, any functional element may perform fewer, or different, operations than those described with respect to the illustrated embodiment. Also, functional elements shown as distinct for purposes of illustration can be incorporated within other functional elements, separated in different hardware, or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

1. A method of associating an event with one of a plurality of tiles, the method comprising:
receiving an event specifying at least an x coordinate and a y coordinate of a user interface;
identifying a subset of candidate tiles by identifying a plurality tiles in which:
the x coordinate is between a minimum x coordinate and a maximum x coordinate of the tile; and
the y coordinate is between a minimum y coordinate and a maximum y coordinate of the tile;
determining whether the event lies within each of the candidate tiles until a relevant tile is identified; and
returning information regarding the relevant tile.

2. The method of claim 1, wherein the plurality of tiles are rhombuses.

3. The method of claim 2, wherein the rhombuses are squares.

4. The method of claim 3, wherein:
a first pair of opposite vertices of each of the squares lies parallel to an x axis of the user interface; and
a second pair of opposite vertices of each of the squares lies parallel to an y axis of the user interface.

5. The method of claim 3, wherein the step of determining whether the event lies within each of the candidate tiles comprises:
determining whether the event lies within a triangle corresponding to an upper half of the rhombus; and
determining whether the event lies within a triangle corresponding to a lower half of the rhombus.

6. The method of claim 1, wherein the plurality of tiles are selected from the group consisting of: circles, ovals, and n-gons.

7. A computer-readable medium storing instructions for implementing a method of associating an event with one of a plurality of tiles, the method comprising:
receiving an event specifying at least an x coordinate and a y coordinate of a user interface;
identifying a subset of candidate tiles by identifying a plurality tiles in which:
the x coordinate is between a minimum x coordinate and a maximum x coordinate of the tile; and
the y coordinate is between a minimum y coordinate and a maximum y coordinate of the tile;
determining whether the event lies within each of the candidate tiles until a relevant tile is identified; and
returning information regarding the relevant tile.

8. The computer-readable medium of claim 7, wherein the plurality of tiles are rhombuses.

9. The computer-readable medium of claim 2, wherein the rhombuses are squares.

10. The computer-readable medium of claim 9, wherein:
a first pair of opposite vertices each of the rhombuses lies parallel to an x axis of the user interface; and
a second pair of opposite vertices each of the rhombuses lies parallel to an y axis of the user interface.

11. The computer-readable medium of claim 9, wherein the step of determining whether the event lies within each of the candidate tiles comprises:
determining whether the event lies within a triangle corresponding to an upper half of the rhombus; and
determining whether the event lies within a triangle corresponding to a lower half of the rhombus.

12. The computer-readable medium of claim 7, wherein the plurality of tiles are selected from the group consisting of: circles, ovals, and n-gons.

13. A system comprising a processor and memory, the memory storing instructions for implementing a method of associating an event with one of a plurality of tiles, the method comprising:
receiving an event specifying at least an x coordinate and a y coordinate of a user interface;
identifying a subset of candidate tiles by identifying a plurality tiles in which:
the x coordinate is between a minimum x coordinate and a maximum x coordinate of the tile; and
the y coordinate is between a minimum y coordinate and a maximum y coordinate of the tile;
determining whether the event lies within each of the candidate tiles until a relevant tile is identified; and
returning information regarding the relevant tile.

14. The system of claim 13, wherein the plurality of tiles are rhombuses.

15. The system of claim 14, wherein the rhombuses are squares.

16. The system of claim 15, wherein:
a first pair of opposite vertices each of the rhombuses lies parallel to an x axis of the user interface; and
a second pair of opposite vertices each of the rhombuses lies parallel to an y axis of the user interface.

17. The system of claim 16, wherein the step of determining whether the event lies within each of the candidate tiles comprises:
determining whether the event lies within a triangle corresponding to an upper half of the rhombus; and
determining whether the event lies within a triangle corresponding to a lower half of the rhombus.

18. The system of claim 13, wherein the plurality of tiles are selected from the group consisting of: circles, ovals, and n-gons.
